(19) United States
(12) Patent Application Publication
(10) Pub. No.: US 2022/0314539 A1
(43) Pub. Date: Oct. 6, 2022

(54) 3D-PRINTING HOUSING NOZZLE

(71) Applicant: BIGREP GMBH, Berlin (DE)

(72) Inventor: Sandro BAYER, Berlin (DE)

(73) Assignee: BIGREP GMBH, Berlin (DE)

(21) Appl. No.: 17/628,165

(22) PCT Filed: Jul. 17, 2020
(86) PCT No.: PCT/EP2020/070260

§ 371 Date: Jan. 18, 2022

(30) Foreign Application Priority Data
Jul. 19, 2019 (LU) LU101315

(51) Int. Cl. B29C 64/209; B29C 64/118

(52) U.S. Cl. CPC B29C 64/209; B29C 64/118; B33Y 30/00

(57) ABSTRACT

The Invention relates to a 3D-printing housing nozzle that comprises a pump housing having a unitary nozzle section with a nozzle opening.

### FIELD

The present invention relates to 3D-printing or additive manufacturing. In particular, the present invention relates to a housing nozzle of a 3D-printhead for a 3D-printer or additive manufacturing machine.

### BACKGROUND

In the field of additive manufacturing an additive manufacturing machine is also called a 3D-printer. In 3D-printing objects or workpieces are built/created/generated by subsequent depositing layers (beads or strands) of build material onto each other. This build material may be plastic material and in particular, the depositing process may be the FFF process. The build material supplied to the 3D-printer may be filament or granulated material.

The 3D-printer usually comprises a printhead that moves in three dimensions. Also, there are 3D-printers that comprise printhead that move in two dimensions and a printbed (the surface or structure on/to which the workpiece(s) are created) that moves in the third dimension. Also, there are printheads that are mounted to a conventional industrial robot such that the printhead can realize complex trajectories. The printhead generally comprises an extruder to apply the material to build up the workpiece.

In the field of FFF printing, the printhead conventionally may comprise a liquefier and a material feed unit. Sometimes the printhead further comprises a melt pump or positive displacement pump downstream the liquefier. Such melt pump may be a gear pump. The material feed unit supplies build material (the material from which the workpiece is created) to the liquefier and subsequently (if applicable) to the melt pump. In the printhead said build material is heated up to its melting temperature. In particular, the build material is heated up in the liquefier and deposited through a nozzle that is connected to the liquefier or melt pump. The deposited build material forms a deposited strand that in turn forms one layer or part of a layer of the workpiece being built. An outlet opening of the nozzle (material outlet) has usually a circular cross section, however, other shapes are possible. The heated and plastic-state build material leaves the printhead/the nozzle trough said outlet opening to form the workpiece(s). The print head may use any known technology such as positive displacement pumps, material feed units (e.g. friction wheel units), screw extruders, gear pumps, liquefiers, tube liquefiers, or any combination of these.

With conventional printheads, the nozzle is threadedly connected to the printhead. This often causes leakage problems due to wear e.g. because of the pressure of the build material being deposited acting on the nozzle. Leakage may cause down time of the printer which is unwanted.

Object of the present application is to overcome the aforementioned drawbacks and to provide a nozzle that renders a material deposition process in an additive manufacturing machine (3D printer) more reliable and predictable. Hence, enhancing the quality of workpieces obtained by such method.

This object is solved by a 3D-printing housing nozzle and a 3D-printhead according to the appended independent claims.

A 3D-printing housing nozzle according to an aspect of the present application comprises a pump housing having a unitary nozzle section and a nozzle opening. The nozzle section is a nozzle part of the pump housing and optionally an area of the pump housing around the nozzle part. This may have the advantage that the overall design of a printhead in which said nozzle is integrated is less complex and easier to assemble. This also may have the advantage that the risk of leakage in the area of the nozzle is eliminated and thus the reliability of a printhead with said nozzle is considerably increased. The pump housing may be part of a positive displacement pump that deposits molten build material.

A 3D-printing housing nozzle according to another aspect of the present application has at least the nozzle section that is case-hardened. This may have the advantage that the wear of the nozzle by the build material is reduced. This may further have the advantage that a friction between the build material and the nozzle section is reduced. The case hardening may be on the inside and/or the outside of the nozzle section.

A 3D-printing housing nozzle according to another aspect of the present application has at least the nozzle section that is coated. This may have the advantage that the wear of the nozzle by the build material is reduced. This may further have the advantage that a friction between the build material and the nozzle section is reduced. The coating may be on the inside and/or the outside of the nozzle section.

A 3D-printing housing nozzle according to another aspect of the present application has a nozzle section that comprises a large and flat surface in the area of the nozzle opening. This may have the advantage that different widths of build material beads may be created. Also, a surface of the deposited material may be smoothed. The nozzle section may be heated.

A 3D-printing housing nozzle according to another aspect of the present application has a nozzle section that comprises a rounded surface in the area of the nozzle opening. This may have the advantage that a surface of the deposited material may be smoothed. The nozzle section may be heated.

A 3D-printing housing nozzle according to another aspect of the present application has a nozzle section that comprises at least one fin. This may have the advantage that the temperature of the nozzle section may be controlled by heating or cooling the at least one fin with a medium and/or a peltier system.

A 3D-printhead according to another aspect of the present application comprises a 3D-printing housing nozzle according to any of the above and a positive displacement pump. The said nozzle is attached to said pump. This may have the advantage that the 3D-printhead is simpler in its design and easier to assemble. Also, a reliability of said printhead will be increased.

A 3D-printhead according to another aspect of the present application comprises a gear pump as the positive displacement pump. This may have the advantage that the 3D-printhead may deposit the build material with high accuracy since the nozzle and the gear pump enable an accurate deposition process without e.g. pressure loss at a threaded nozzle.

The above aspects may be freely combined. For a better understanding of the invention the latter will be explained in view of the appended figures. The figures respectively show in very simplified and schematically depiction:

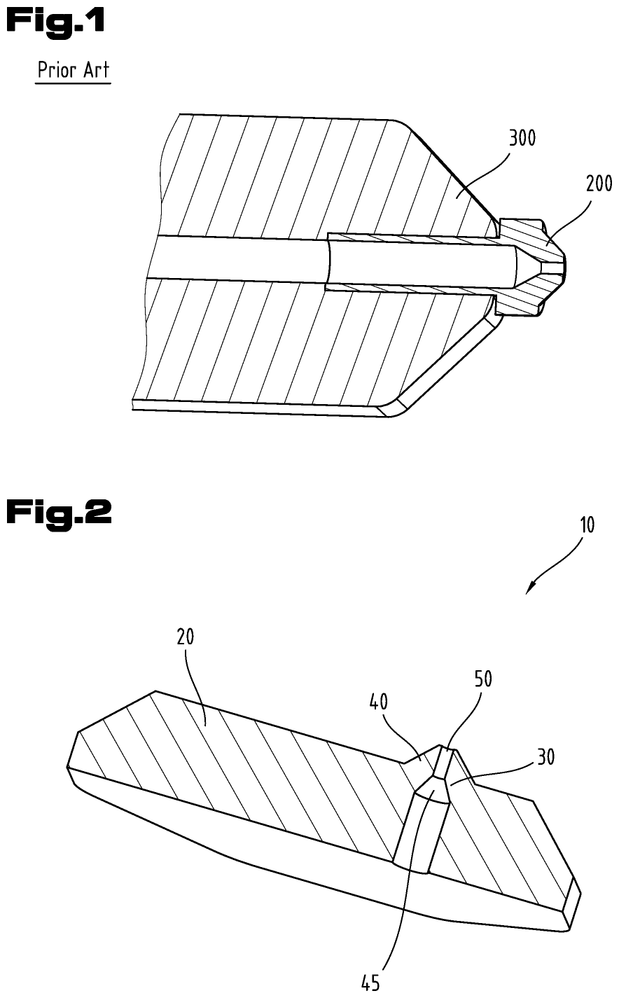

FIG. 1 a nozzle according to the prior art.

FIG. 2 an embodiment of a 3D-printing housing nozzle.

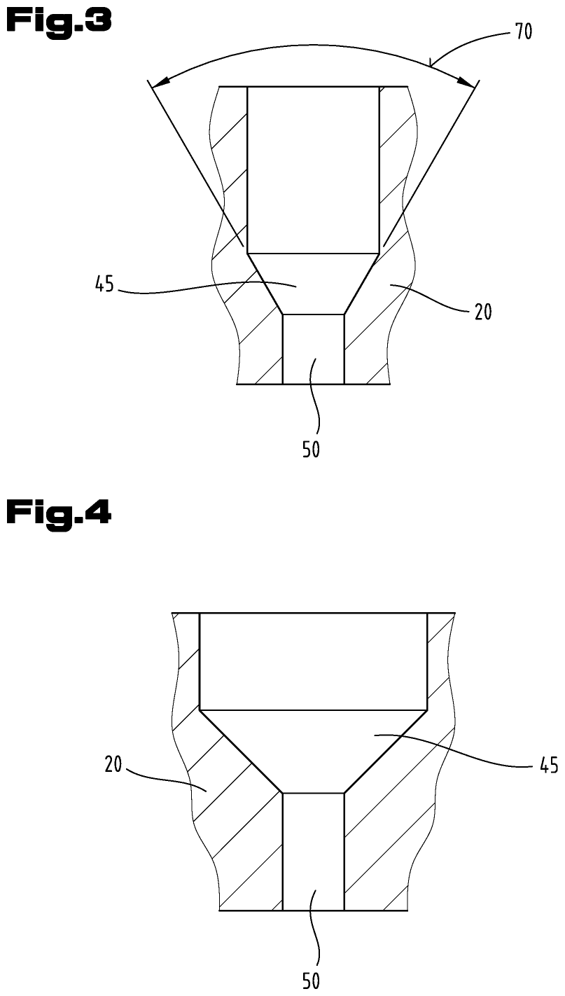

FIGS. 3 to 7 different alternatives of an inner geometry of a 3D-printing housing nozzle.

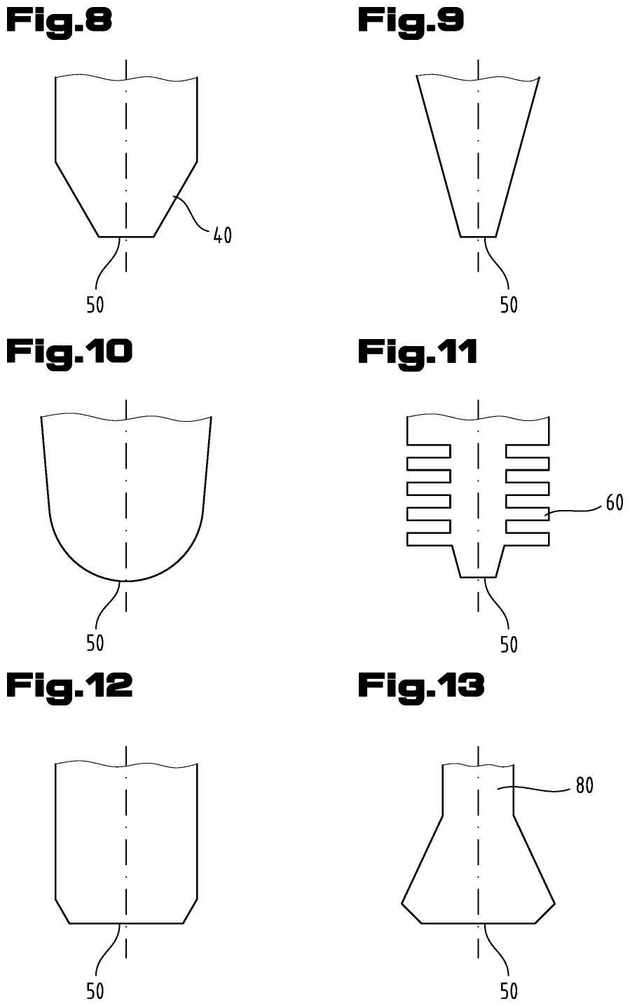

FIGS. 8 to 13 different alternatives of an outer geometry of a 3D-printing housing nozzle.

It is to be noted that in the different embodiments described herein same parts/elements are numbered with same reference signs, however, the disclosure in the detailed description may be applied to all parts/elements having the regarding reference signs. Also, the directional terms/position indicating terms chosen in this description like up, upper, down, lower downwards, lateral, sideward are referring to the directly described figure and may correspondingly be applied to the new position after a change in position or another depicted position in another figure.

### DETAILED DESCRIPTION OF THE FIGURES

FIG. 1 depicts an example of a nozzle according to the prior art. Here, the nozzle 200 is screwed into a housing 300. The connection between the nozzle 200 and the housing 300 may also be a press fitting and/or by means of an adhesive.

FIG. 2 depicts an embodiment of a 3D-printing housing nozzle according to the present application where a pump housing 20 comprises a nozzle section 30. The nozzle section 30 comprises an inner geometry 45 and an outer geometry 40 as well as a nozzle opening 50. The inner geometry 45 reduces from an initial diameter on the left side of FIG. 2 to a smaller diameter that corresponds to the diameter of the nozzle opening 50. The transition from the initial diameter to the diameter of the nozzle opening 50 is here in a funnel-shape having a flat transition surface.

FIG. 3 depicts an alternative inner geometry 45 of the nozzle section 30. Here, the inner geometry 45 is similar to the inner geometry depicted in FIG. 2. In this case an opening angle of the funnel-shape is narrower, than in FIG. 2. This is for example advantageous if the build material contains fibers. The fibers contained in the build material are better orientated (i.e. parallel to e.g. a center line of the nozzle opening or a middle line of a nozzle bore). The angle of the funnel-shaped opening may also be dependent on the length of the fibers contained in the build material. A range for an opening angle 70 is from 20° up to 40°.

FIG. 4 depicts yet an alternative inner geometry 45 of the nozzle section 30, similar to the inner geometry 45 depicted in FIGS. 2 and 3. However here, an opening angle of the funnel-shape is wider, than in FIGS. 2 and 3. A range for an opening angle 70 is from 40° up to 160°.

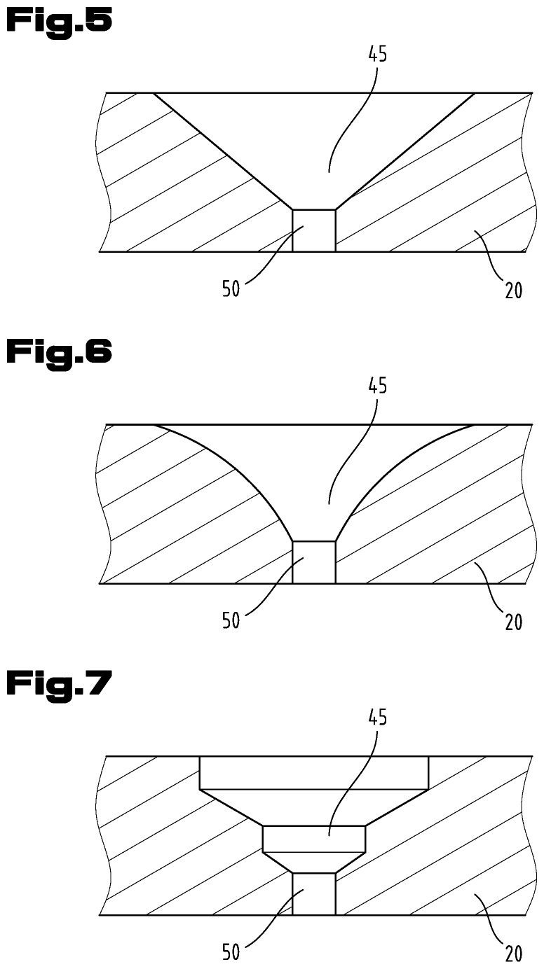

FIG. 5 depicts yet an alternative inner geometry 45 of the nozzle section 30, similar to the inner geometry 45 depicted in FIGS. 2 to 4. However here, the initial diameter is very large in comparison to the diameter of the nozzle opening. The initial diameter may entirely cover an outlet of a positive displacement pump that is located in the vicinity of the initial diameter or that is attached directly to the pump housing 20 on the upper part in FIG. 5. The overall shape of the inner geometry 45 depicted in FIG. 5 is still funnel-shaped.

FIG. 6 depicts yet an alternative inner geometry 45 of the nozzle section 30, similar to the inner geometry 45 depicted in FIG. 5. However here, the funnel-shape has no flat surfaces as for example in FIG. 5 but is curved.

FIG. 7 depicts yet an alternative inner geometry 45 of the nozzle section 30, similar to the inner geometry 45 depicted in FIGS. 2 to 4. However here, the initial diameter (top of FIG. 7) is reduced to the diameter of the nozzle opening 50 in steps similar to the inner geometry 45 of FIGS. 2 to 4.

FIG. 8 depicts an alternative outer geometry 40 of the nozzle section 30 to the one depicted in FIG. 2. The outer geometry 40 in FIG. 8 is not cone-shaped as in FIG. 2 but has a cylindric section on the side that is orientated to the pump housing 20 (upper part in FIG. 8).

FIG. 9 depicts yet an alternative outer geometry 40 of the nozzle section 30, similar to the outer geometry 40 depicted in FIG. 2. However here, the outer geometry 40 is more pointed than the one depicted in FIGS. 2 and 8 in order to reduce an area around the nozzle opening 50 to a minimum and thus reduce a contact surface with the deposited build material.

FIG. 10 depicts yet an alternative outer geometry 40 of the nozzle section 30. Here, the outer geometry 40 is rounded and in particular in an area of the nozzle opening 50. With this outer geometry 40 a surface of the deposited build material can be smoothed.

FIG. 11 depicts yet an alternative outer geometry 40 of the nozzle section 30. Here, the outer geometry 40 comprises at least one fin 60 (here there are multiple fins depicted). These fins 60 may serve for cooling or heating the nozzle section 30 and consequently influence the properties of the build material. The at least one fin 60 may be cooled or heated by a medium. This medium may be air, water or coolant (the coolant may be hot or cold). Also, the at least one fin may be cooled or heated by a peltier system.

FIG. 12 depicts yet an alternative outer geometry 40 of the nozzle section 30. Here, the outer geometry 40 has a relatively large and flat surface in the area of the nozzle opening 50. This results in a large surface contact with the deposited build material. This may have the advantage that the deposited material may be spread out by the relatively large and flat surface of the nozzle section 30. Here, more material as usually needed will be deposited and then spread out by the nozzle section 30. This may have the advantage that a considerably broader strand or bead may be printed using the same nozzle or printhead. In other words, it is possible to print different bead widths with the same nozzle section dependent inter alia on the amount of build material deposited trough the nozzle opening 50. Also, the outer geometry 40 may be heated and the relatively large and flat surface may be used for smoothening the deposited strand(s).

FIG. 13 depicts yet an alternative outer geometry 40 of the nozzle section 30. Here, the outer geometry 40 also has a relatively large and flat surface (similar to FIG. 12), however, in the upper part that is connected to the rest of the pump housing 20 there is a reduction in the cross section of the nozzle section 30. With other words, between the nozzle opening 50 and the rest of the pump housing 40 is a necking 80. The necking 80 e.g. allows for a direct cooling or heating of this portion and thus may prevent e.g. clogging.

The outer geometries 40 depicted in FIGS. 8 to 13 are all connected to the rest of the respective pump housing 20 on the cut line that is depicted in the upper part of each figure.

In all figures like reference sings are used for like or similar parts/elements as in the other figures. Thus, a detailed explanation of such part/element will only be given one for the sake of brevity. Although except for FIG. 6 all funnel-shapes are depicted with flat (transition) surfaces, the surfaces of the funnel-shapes in the above embodiments/alternatives may have also curved surfaces.

The embodiments depict possible variations of carrying out the invention, however, it is to be noted that the invention is not limited to the depicted embodiments/variations but numerous combinations of the here described embodiments/variations are possible and these combinations lie in the field of the skills of the person skilled in the art being motivated by this description.

The scope of protection is determined by the appended claims. The description and drawings, however, are to be considered when interpreting the claims. Single features or feature combinations of the described and/or depicted features may represent independent inventive solutions. The object of the independent solutions may be found in the description.

All notations of ranges of values in the present description are to be understood as to also comprise and disclose all arbitrary sub-ranges therein, e.g. the disclosure 1 to 10 is to be understood that all sub-ranges starting from the lower limit 1 up to the upper limit 10 are also comprised and disclosed, i.e. all sub-ranges starting with a lower limit of 1 or bigger and end with an upper limit of 10 or smaller, e.g. 1 to 1.7, or 3.2 to 8.1, or 5.5 to 10. Only one digit after the comma is described, however the same applies mutates mutandis to any given number of digits after the comma.

It is further to be noted that for a better understanding parts/elements are depicted to some extend not to scale and/or enlarged and/or down scaled.

### REFERENCE SIGN LIST

10 3D-printing housing nozzle
20 pump housing
30 nozzle section
40 outer geometry
45 inner geometry
50 nozzle opening
60 fin
70 opening angle
80 necking
200 housing
300 threaded nozzle

1. A 3D-printing housing nozzle (10), comprising a pump housing (20) having a unitary nozzle section (30) with a nozzle opening (50).

2. The 3D-printing housing nozzle (10) according to claim 1, wherein at least the nozzle section (30) is case-hardened.

3. The 3D-printing housing nozzle (10) according to claim 1, wherein at least the nozzle section (30) is coated.

4. The 3D-printing housing nozzle (10) according to claim 1, wherein the nozzle section (30) comprises a large and flat surface in the area of the nozzle opening (50).

5. The 3D-printing housing nozzle (10) according to claim 1, wherein the nozzle section (30) comprises a rounded surface in the area of the nozzle opening (50).

6. The 3D-printing housing nozzle (10) according to claim 1, wherein the nozzle section (30) comprises at least one fin (60).

7. The 3D-printhead comprising a 3D-printing housing nozzle according to claim 1 and further comprising a positive displacement pump, wherein the 3D-printing housing nozzle is attached to said positive displacement pump.

8. The 3D-printhead according to claim 7, wherein the positive displacement pump is a gear pump.
